(19) United States
(12) Patent Application Publication
(10) Pub. No.: US 2025/0309732 A1
(43) Pub. Date: Oct. 2, 2025

(54) ELECTRIC APPARATUS

(71) Applicant: HONDA MOTOR CO., LTD., Tokyo (JP)

(72) Inventors: Somei Nakatomi, Wako-shi (JP); Yoshihisa Kubota, Wako-shi (JP)

(21) Appl. No.: 19/038,733

(22) Filed: Jan. 28, 2025

(30) Foreign Application Priority Data
Mar. 28, 2024 (JP) 2024-053931

(51) Int. Cl. H02K 11/25; H02K 1/16; H02K 3/28; H02K 11/33

(52) U.S. Cl. CPC H02K 11/25; H02K 1/16; H02K 3/28; H02K 11/33

(57) ABSTRACT

An electric apparatus includes an electric power storage device, a rotary electric machine, an electric power control unit, a motor temperature sensor, and a battery temperature sensor. The rotary electric machine includes each coil. The electric power control unit includes a first full-bridge circuit and a second full-bridge circuit that are connected to both ends of each coil, and a third full-bridge circuit and a fourth full-bridge circuit that are connected to both ends of each coil. The electric power control unit controls electric power supply of each coil in accordance with the temperature acquired by each temperature sensor, and switches between and performs a first mode in which a heat generation amount of the electric power storage device is larger than a heat generation amount of the rotary electric machine and a second mode in which a heat generation amount of the electric power storage device is smaller than that of the first mode.

### CROSS-REFERENCE TO RELATED APPLICATION

Priority is claimed on Japanese Patent Application No. 2024-053931, filed on Mar. 28, 2024, the contents of which are incorporated herein by reference.

### BACKGROUND

### Field of the Invention

The present invention relates to an electric apparatus.

### Background

In recent years, in order to ensure that more people have access to affordable, reliable, sustainable, and advanced energy, research and development relating to charging and electric power supply in a mobility on which a secondary battery is mounted, which contributes to energy efficiency, has been conducted.

In the related art, for example, a control device is known which heats a battery by a d-axis current value in a vector control of a travel motor when a vehicle is stopped (for example, refer to Japanese Unexamined Patent Application, First Publication No. 2012-165526).

Further, for example, a control device is known in which electric power supply is performed so as to generate a torque in an opposite direction to each other in two motors connected to a common power transmission gear, and thereby, the two motors are warmed up (for example, refer to Japanese Unexamined Patent Application, First Publication No. 2016-178842).

### SUMMARY

In the technique relating to charging and electric power supply in a mobility on which a secondary battery is mounted, it is a problem to improve energy efficiency while preventing a device configuration from becoming complicated. For example, as in the control device of the related art described above, when each of an electric power storage device and an electric motor is independently heated by different methods from each other, the control of the heating becomes complicated, and there is a possibility that it is impossible to perform a cooperative control, and it is impossible to appropriately set the temperatures of both the electric power storage device and the electric motor.

The present application aims at achieving an improvement of efficiency while preventing a control at the time of warm-up from becoming complicated. Further, the present application contributes to energy efficiency.

An electric apparatus (for example, an electric apparatus 10 in the embodiment) according to a first aspect of the present invention includes: an electric power storage device (for example, an electric power storage device 11 in the embodiment); a rotary electric machine (for example, a rotary electric machine 16 (M) in the embodiment) having a plurality of coils (for example, an α-phase first coil 23 (α1), an α-phase second coil 24 (α2), a β-phase first coil 33 (β1), and a β-phase second coil 34 (β2) in the embodiment); an electric power control unit (for example, an electric power control unit 10a in the embodiment) that is connected to the electric power storage device and the rotary electric machine and controls electric power transfer of each of the electric power storage device and the rotary electric machine; a first temperature acquisition portion (for example, a battery temperature sensor 40b in the embodiment) that acquires the temperature of the electric power storage device; and a second temperature acquisition portion (for example, a motor temperature sensor 40a in the embodiment) that acquires the temperature of the rotary electric machine, wherein by controlling electric power supply of the plurality of coils in accordance with each temperature acquired by the first temperature acquisition portion and the second temperature acquisition portion, the electric power control unit switches between and performs a first mode in which a heat generation amount of the electric power storage device is larger than a heat generation amount of the rotary electric machine and a second mode in which a heat generation amount of the electric power storage device is smaller than the heat generation amount of the electric power storage device in the first mode.

A second aspect is the electric apparatus according to the first aspect described above, wherein the rotary electric machine may include a stator core (for example, a stator core 42 in the embodiment) on which a slot (for example, a slot 43 in the embodiment) is formed, the plurality of coils may include: a plurality of first coils (for example, the α-phase first coil 23 (α1) and the α-phase second coil 24 (α2) in the embodiment) that share the slot (for example, the slot 43 in the embodiment) of the stator core and are magnetically coupled; and a plurality of second coils (for example, the β-phase first coil 33 (β1) and the β-phase second coil 34 (β2) in the embodiment) that share the slot (for example, the slot 43 in the embodiment) of the stator core and are magnetically coupled, the electric power control unit may include: a plurality of first full-bridge circuits (for example, a first full-bridge circuit 12a and a second full-bridge circuit 12b in the embodiment) connected to the plurality of first coils; and a plurality of second full-bridge circuits (for example, a third full-bridge circuit 13a and a fourth full-bridge circuit 13b in the embodiment) connected to the plurality of second coils, a switching phase of each of the plurality of first full-bridge circuits and the plurality of second full-bridge circuits may be in a reverse phase in the first mode, and the switching phase of each of the plurality of first full-bridge circuits and the plurality of second full-bridge circuits may be in phase in the second mode.

A third aspect is the electric apparatus according to the second aspect described above, wherein spatial phases of the plurality of first coils and the plurality of second coils may be orthogonal to each other, the plurality of first coils and the plurality of second coils may be open-ended, the electric power control unit may set a phase difference between the switching phase of the plurality of first full-bridge circuits and the switching phase of the plurality of second full-bridge circuits to be 90° in accordance with each temperature acquired by the first temperature acquisition portion and the second temperature acquisition portion.

A fourth aspect is the electric apparatus according to the first aspect described above, wherein the rotary electric machine may include a stator core (for example, a stator core 42 in the embodiment) on which a slot (for example, a slot 43 in the embodiment) is formed, the plurality of coils may include: a plurality of first coils (for example, the α-phase first coil 23 (α1) and the α-phase second coil 24 (α2) in the embodiment) that share the slot (for example, the slot 43 in the embodiment) of the stator core and are magnetically coupled; and a plurality of second coils (for example, the β-phase first coil 33 (β1) and the β-phase second coil 34 (β2) in the embodiment) that share the slot (for example, the slot 43 in the embodiment) of the stator core and are magnetically coupled, the electric power control unit may include: a plurality of first full-bridge circuits (for example, a first full-bridge circuit 12a and a second full-bridge circuit 12b in the embodiment) that are connected to the plurality of first coils; an inter-coil connection-disconnection device (for example, a first switch 22 in the embodiment) that is connected between the plurality of first coils; two connection-disconnection devices (for example, a first connection-disconnection device 25 and a second connection-disconnection device 26 in the embodiment) that are connected between positive electrodes and between negative electrodes of the plurality of first full-bridge circuits; and a plurality of second full-bridge circuits (for example, a third full-bridge circuit 13a and a fourth full-bridge circuit 13b in the embodiment) that are connected to the plurality of second coils, a switching phase of each of the plurality of first full-bridge circuits and the plurality of second full-bridge circuits may be in a reverse phase in the first mode, and in the second mode, conversion between DC electric power may be performed by the plurality of first full-bridge circuits by causing the inter-coil connection-disconnection device to be in a connection state, causing a first connection-disconnection device (for example, the first connection-disconnection device 25 in the embodiment) of the two connection-disconnection devices to be in a disconnection state, and causing a second connection-disconnection device (for example, the second connection-disconnection device 26 in the embodiment) of the two connection-disconnection devices to be in a connection state.

According to the first aspect described above, by switching between and performing the first mode and the second mode in accordance with the temperature of each of the electric power storage device and the rotary electric machine, for example, even when the difference between the temperature of the electric power storage device and the temperature of the rotary electric machine is large or the like, it is possible to appropriately control the temperature of each of the electric power storage device and the rotary electric machine.

In the case of the second aspect described above, by the switching between the reverse-phase state and the in-phase state of the switching phase, it is possible to reciprocally switch the magnitude of an iron loss corresponding to an inductance and the magnitude of a current or the magnitude of a current ripple corresponding to the inductance. For example, it is possible to easily adjust the relative amount of the heating of the electric power storage device by the current ripple or the current and the heating of the rotary electric machine by the iron loss, and it is possible to realize power saving.

In the case of the third aspect described above, it is possible to reduce the amplitude of a current that flows through the electric power storage device, and the relative amount of the heating of the electric power storage device and the heating of the rotary electric machine can be adjusted in more detail.

In the case of the fourth aspect described above, in the second mode, for example, as compared with the case where the switching phase is in phase or the like, it is possible to reduce the amplitude of a current that flows through the electric power storage device, and it is possible to prioritize the heating of the rotary electric machine with further power saving.

### BRIEF DESCRIPTION OF THE DRAWINGS

FIG. 1 is a view showing the configuration of an electric apparatus of an embodiment of the present invention.

FIG. 2 is a configuration view of each full-bridge circuit and a rotary electric machine in the electric apparatus of the embodiment of the present invention.

FIG. 3 is a flowchart showing an operation of the electric apparatus of the embodiment of the present invention.

FIG. 4 is a circuit diagram showing the flow of a current of a first mode in the electric apparatus of the embodiment of the present invention.

FIG. 5 is a view showing the change of a current that flows through each coil and an electric power storage device in the first mode in the electric apparatus of the embodiment of the present invention.

FIG. 6 is a circuit diagram showing the flow of a current of a second mode in the electric apparatus of the embodiment of the present invention.

FIG. 7 is a view showing the change of a current that flows through each coil and the electric power storage device in the second mode in the electric apparatus of the embodiment of the present invention.

FIG. 8 is a view showing the change of a current that flows through each coil and an electric power storage device in a first mode of an electric apparatus in a first modification example of the embodiment of the present invention.

FIG. 9 is a flowchart showing an operation of an electric apparatus of a second modification example of the embodiment of the present invention.

FIG. 10 is a circuit diagram showing the flow of a current of a third mode in the electric apparatus of the second modification example of the embodiment of the present invention.

FIG. 11 is a view showing the change of a current that flows through an α-phase second coil and an electric power storage device in the third mode in the electric apparatus of the second modification example of the embodiment of the present invention.

FIG. 12 is a configuration view of a rotary electric machine of an electric apparatus in a third modification example of the embodiment of the present invention.

### DESCRIPTION OF EMBODIMENTS

Hereinafter, an electric apparatus according to an embodiment of the present invention will be described with reference to the accompanying drawings.

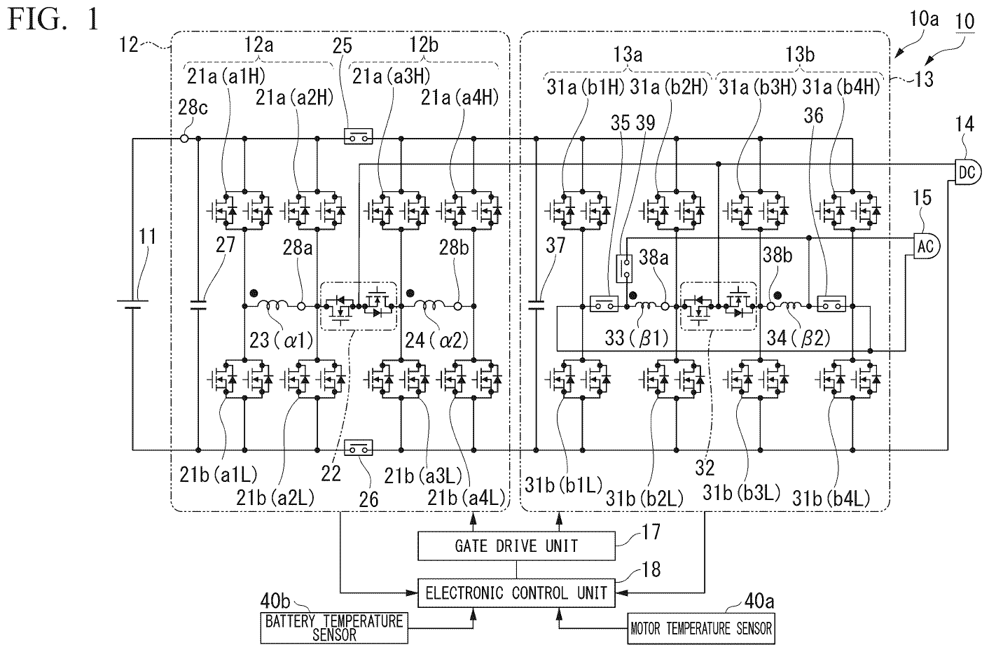

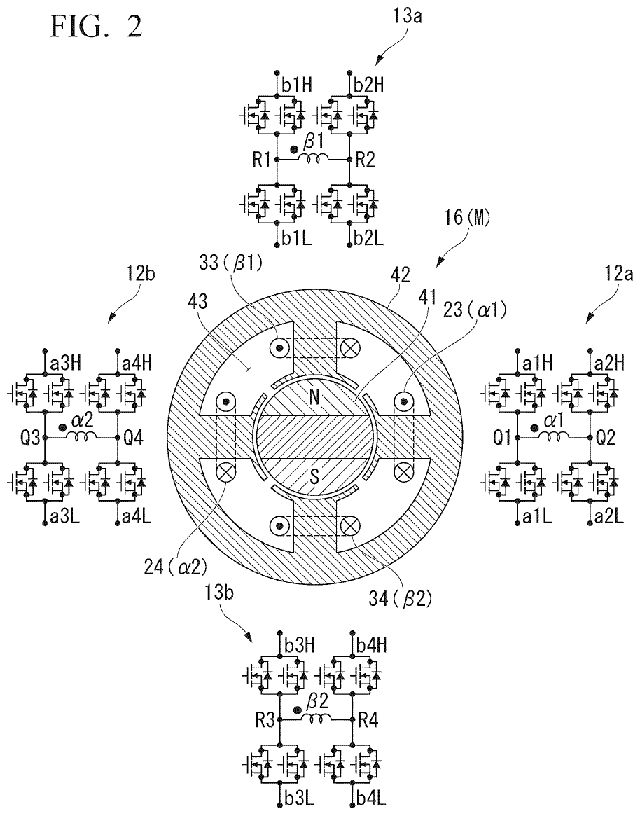

FIG. 1 is a view showing the configuration of an electric apparatus 10 of an embodiment. FIG. 2 is a configuration view of each full-bridge circuit 12a, 12b, 13a, 13b and a rotary electric machine 16 in the electric apparatus 10 of the embodiment.

The electric apparatus 10 of the embodiment is mounted, for example, on an electric vehicle, an electric movable body, an electric machine, an electric power source device, and the like. The electric vehicle is, for example, an electric automobile that includes a rotary electric machine as a power source, a saddle riding vehicle, a kick skater, a hybrid vehicle by a combination of a rotary electric machine and an internal combustion engine, a fuel cell vehicle by a combination of an electric power storage device and a fuel cell, and the like. The electric movable body is, for example, a robot, a flying vehicle, a movable body on water, an underwater movable body, and the like.

The electric machine is, for example, a construction machine that includes a rotary electric machine as a power source and the like. The electric power source device is, for example, a stationary or mobile electric power source device that performs discharging and charging of an electric power storage device and the like.

### (Electric Apparatus)

As shown in FIG. 1 and FIG. 2, the electric apparatus 10 of the embodiment includes, for example, an electric power storage device 11, a first electric power conversion portion 12, a second electric power conversion portion 13, a DC electric power source connection portion 14, an AC electric power source connection portion 15, a rotary electric machine 16 (M), a gate drive unit 17, and an electronic control unit 18. For example, the first electric power conversion portion 12, the second electric power conversion portion 13, the DC electric power source connection portion 14, the AC electric power source connection portion 15, the gate drive unit 17, and the electronic control unit 18 constitute an electric power control unit 10a.

The electric power storage device 11 is connected to the first electric power conversion portion 12 and the second electric power conversion portion 13 described later.

The electric power storage device 11 includes, for example, a plurality of battery cells that are connected in series or in parallel. Each battery cell is, for example, a lead storage battery, a lithium-ion battery, a secondary battery such as a nickel hydride battery and an all-solid-state battery, a capacitor such as an electric double layer capacitor, a compound battery by a combination of a secondary battery and a capacitor, or the like. Each battery cell repeatedly performs charging and discharging. The electric power storage device 11 transfers electric power to and from the rotary electric machine 16 via the electric power control unit 10a. The electric power storage device 11 is charged by an external electric power source (an external DC electric power source and an external AC electric power source).

The first electric power conversion portion 12 includes a first full-bridge circuit 12a and a second full-bridge circuit 12b.

Each of the first full-bridge circuit 12a and the second full-bridge circuit 12b includes, for example, a so-called H-bridge circuit formed of a plurality of switching elements connected in two phases by bridge connection. Each switching element is, for example, a transistor of a SiC (Silicon Carbide) or the like, such as a MOSFET (Metal Oxide Semi-conductor Field Effect Transistor) or an IGBT (Insulated Gate Bipolar Transistor). Each switching element is, for example, an N-channel type MOSFET.

The plurality of switching elements are, for example, a pair of transistors forming each of high-side arm and low-side arm element portions 21a, 21b that form a pair in each phase. Each pair of transistors of each element portion 21a, 21b is a pair of transistors that are connected, for example, in parallel.

Each full-bridge circuit 12a, 12b may include, for example, a rectifier element such as a reflux diode which is connected in parallel between a collector and an emitter of each transistor in a forward direction toward the collector from the emitter.

The first electric power conversion portion 12 includes, for example, a first switch 22 (inter-coil connection-disconnection device) that is connected between neutral points Q2, Q3 of the first full-bridge circuit 12a and the second full-bridge circuit 12b. The neutral point Q2 of the first full-bridge circuit 12a is, for example, a connection point between a high-side arm element portion 21a (a2H) and a low-side arm element portion 21b (a2L) that are connected in series in a second phase among first and second phases of two phases of the first full-bridge circuit 12a. For example, the neutral point Q2 is a connection point between a source of the high-side arm element portion 21a (a2H) and a drain of the low-side arm element portion 21b (a2L). The neutral point Q3 of the second full-bridge circuit 12b is, for example, a connection point between a high-side arm element portion 21a (a3H) and a low-side arm element portion 21b (a3L) that are connected in series in a first phase among first and second phases of two phases of the second full-bridge circuit 12b. For example, the neutral point Q3 is a connection point between a source of the high-side arm element portion 21a (a3H) and a drain of the low-side arm element portion 21b (a3L).

The first switch 22 is, for example, a bidirectional switch formed of two switching elements. Each switching element is a transistor such as a MOSFET or an IGBT and is, for example, an N-channel type MOSFET. The first switch 22 includes, for example, two transistors connected reversely in series. For example, the sources of the two transistors are connected to each other, and thereby, the two transistors are connected in series in a direction opposite to each other. The first switch 22 switches conduction and cutoff of a current between the neutral points Q2, Q3 by ON (conduction)/OFF (cutoff) of the two transistors.

Each transistor may include a rectifier element such as a reflux diode which is connected in parallel between a collector and an emitter in a forward direction toward the collector from the emitter.

The first electric power conversion portion 12 is connected to an α-phase first coil 23 (α1) and an α-phase second coil 24 (α2) of the rotary electric machine 16 described later. The α-phase first coil 23 is connected between neutral points Q1, Q2 of the first full-bridge circuit 12a. The α-phase second coil 24 (α2) is connected between neutral points Q3, Q4 of the second full-bridge circuit 12b. The neutral point Q1 of the first full-bridge circuit 12a is, for example, a connection point between a high-side arm element portion 21a (a1H) and a low-side arm element portion 21b (a1L) that are connected in series in the first phase of the first full-bridge circuit 12a. For example, the neutral point Q1 is a connection point between a source of the high-side arm element portion 21a (a1H) and a drain of the low-side arm element portion 21b (a1L). The neutral point Q4 of the second full-bridge circuit 12b is, for example, a connection point between a high-side arm element portion 21a (a4H) and a low-side arm element portion 21b (a4L) that are connected in series in the second phase of the second full-bridge circuit 12b. For example, the neutral point Q4 is a connection point between a source of the high-side arm element portion 21a (a4H) and a drain of the low-side arm element portion 21b (a4L).

The first electric power conversion portion 12 includes a first connection-disconnection device 25 connected between positive electrodes of the first full-bridge circuit 12a and the second full-bridge circuit 12b and a second connection-disconnection device 26 connected between negative electrodes of the first full-bridge circuit 12a and the second full-bridge circuit 12b.

Each of the first connection-disconnection device 25 and the second connection-disconnection device 26 is, for example, a contactor and switches between ON (conduction) and OFF (cutoff) of the connection between the first full-bridge circuit 12a and the second full-bridge circuit 12b.

The first electric power conversion portion 12 includes, for example, a capacitor (condenser) 27 connected between the positive electrode and the negative electrode. For example, the capacitor 27 smooths voltage variation generated in accordance with a switching operation between ON (conduction) and OFF (cutoff) of each switching element of the first electric power conversion portion 12.

The first electric power conversion portion 12 includes, for example, a first current sensor 28a arranged between the α-phase first coil 23 (α1) and the neutral point Q2, a second current sensor 28b arranged between the α-phase second coil 24 (α2) and the neutral point Q4, and a third current sensor 28c arranged between the electric power storage device 11 and the first electric power conversion portion 12.

For example, the first current sensor 28a detects a current that flows through the α-phase first coil 23 (α1). The second current sensor 28b detects a current that flows through the α-phase second coil 24 (α2).

The third current sensor 28c detects a current that flows between the first electric power conversion portion 12 and the electric power storage device 11.

The second electric power conversion portion 13 includes a third full-bridge circuit 13a and a fourth full-bridge circuit 13b.

Each of the third full-bridge circuit 13a and the fourth full-bridge circuit 13b includes, for example, a so-called H-bridge circuit formed of a plurality of switching elements connected in two phases by bridge connection. Each switching element is, for example, a transistor of a SiC or the like, such as a MOSFET or an IGBT. Each switching element is, for example, an N-channel type MOSFET.

The plurality of switching elements are, for example, a pair of transistors forming each of high-side arm and low-side arm element portions 31a, 31b that form a pair in each phase. Each pair of transistors of each element portion 31a, 31b are connected, for example, in parallel.

Each full-bridge circuit 13a, 13b may include, for example, a rectifier element such as a reflux diode which is connected in parallel between a collector and an emitter of each transistor in a forward direction toward the collector from the emitter.

The second electric power conversion portion 13 includes, for example, a second switch 32 connected between neutral points R2, R3 of the third full-bridge circuit 13a and the fourth full-bridge circuit 13b. The neutral point R2 of the third full-bridge circuit 13a is, for example, a connection point between a high-side arm element portion 31a (b2H) and a low-side arm element portion 31b (b2L) that are connected in series in a second phase among first and second phases of two phases of the third full-bridge circuit 13a. For example, the neutral point R2 is a connection point between a source of the high-side arm element portion 31a (b2H) and a drain of the low-side arm element portion 31b (b2L). The neutral point R3 of the fourth full-bridge circuit 13b is, for example, a connection point between a high-side arm element portion 31a (b3H) and a low-side arm element portion 31b (b3L) that are connected in series in a first phase among first and second phases of two phases of the fourth full-bridge circuit 13b. For example, the neutral point R3 is a connection point between a source of the high-side arm element portion 31a (b3H) and a drain of the low-side arm element portion 31b (b3L).

The second switch 32 is, for example, a bidirectional switch formed of two switching elements. Each switching element is a transistor such as a MOSFET or an IGBT and is, for example, an N-channel type MOSFET. The second switch 32 includes, for example, two transistors connected reversely in series. For example, the sources of the two transistors are connected to each other, and thereby, the two transistors are connected in series in a direction opposite to each other. The second switch 32 switches conduction and cutoff of a current between the neutral points R2, R3 by ON (conduction)/OFF (cutoff) of the two transistors.

Each transistor may include a rectifier element such as a reflux diode which is connected in parallel between a collector and an emitter in a forward direction toward the collector from the emitter.

The second electric power conversion portion 13 is connected to a β-phase first coil 33 (β1) and a β-phase second coil 34 (β2) of the rotary electric machine 16 described later. The β-phase first coil 33 is connected between neutral points R1, R2 of the third full-bridge circuit 13a. The β-phase second coil 34 (β2) is connected between neutral points R3, R4 of the fourth full-bridge circuit 13b. The neutral point R1 of the third full-bridge circuit 13a is, for example, a connection point between a high-side arm element portion 31a (b1H) and a low-side arm element portion 31b (b1L) that are connected in series in the first phase of the third full-bridge circuit 13a. For example, the neutral point R1 is a connection point between a source of the high-side arm element portion 31a (b1H) and a drain of the low-side arm element portion 31b (b1L). The neutral point R4 of the fourth full-bridge circuit 13b is, for example, a connection point between a high-side arm element portion 31a (b4H) and a low-side arm element portion 31b (b4L) that are connected in series in the second phase of the fourth full-bridge circuit 13b. For example, the neutral point R4 is a connection point between a source of the high-side arm element portion 31a (b4H) and a drain of the low-side arm element portion 31b (b4L).

The second electric power conversion portion 13 includes a third connection-disconnection device 35 connected between one end of the β-phase first coil 33 (β1) and the third full-bridge circuit 13a and a fourth connection-disconnection device 36 connected between one end of the β-phase second coil 34 (β2) and the fourth full-bridge circuit 13b.

Each of the third connection-disconnection device 35 and the fourth connection-disconnection device 36 is, for example, a contactor. The third connection-disconnection device 35 is connected, for example, between the one end of the β-phase first coil 33 (β1) and the neutral point R1 of the first phase of the third full-bridge circuit 13a and switches between ON (conduction) and OFF (cutoff) of the connection between the β-phase first coil 33 (β1) and the neutral point R1. The fourth connection-disconnection device 36 is connected, for example, between the one end of the β-phase second coil 34 (β2) and the neutral point R4 of the second phase of the fourth full-bridge circuit 13b and switches between ON (conduction) and OFF (cutoff) of the connection between the β-phase second coil 34 (β2) and the neutral point R4.

The second electric power conversion portion 13 includes, for example, a capacitor (condenser) 37 connected between the positive electrode and the negative electrode. For example, the capacitor 37 smooths voltage variation generated in accordance with a switching operation between ON (conduction) and OFF (cutoff) of each switching element of the second electric power conversion portion 13.

The second electric power conversion portion 13 includes, for example, a fourth current sensor 38a arranged between the β-phase first coil 33 (β1) and the neutral point R2 and a fifth current sensor 38b arranged between the β-phase second coil 34 (β2) and the neutral point R4.

For example, the fourth current sensor 38a detects a current that flows through the β-phase first coil 33 (β1). The fifth current sensor 38b detects a current that flows through the β-phase second coil 34 (β2).

The second electric power conversion portion 13 includes, for example, a fifth connection-disconnection device 39 that is connected between the AC electric power source connection portion 15 described later and a connection point between the β-phase first coil 33 (β1) and the third connection-disconnection device 35. The fifth connection-disconnection device 39 is, for example, a contactor. The fifth connection-disconnection device 39 switches between ON (conduction) and OFF (cutoff) of the connection between the AC electric power source connection portion 15 and the β-phase first coil 33 (β1).

The DC electric power source connection portion 14 and the AC electric power source connection portion 15 include, for example, a connection device (connector) or the like for DC electric power and for AC electric power of a predetermined standard. The DC electric power source connection portion 14 and the AC electric power source connection portion 15 are connected, for example, to a DC electric power source (external DC electric power source) and an AC electric power source (external AC electric power source) at the outside on the basis of a commercial electric power source or the like connected to an electric power system.

The DC electric power source connection portion 14 is connected, for example, to the negative electrode of the second electric power conversion portion 13 and to a neutral point (that is, a point between the two transistors connected reversely in series) of each of the first switch 22 and the second switch 32.

The AC electric power source connection portion 15 is connected, for example, to each of the first neutral point R1 and the fourth neutral point R4 of the second electric power conversion portion 13 and to the connection point between the β-phase first coil 33 (β1) and the third connection-disconnection device 35 and the fifth connection-disconnection device 39.

The rotary electric machine 16 (M) is, for example, a two-phase AC brushless DC motor. The rotary electric machine 16 includes, for example, the α-phase first coil 23 (α1), the α-phase second coil 24 (α2), the β-phase first coil 33 (β1), the β-phase second coil 34 (β2), a rotor 41, and a stator core 42.

The rotor 41 includes a field permanent magnet. Each coil α1, α2, β1, β2 that generates a rotating magnetic field which rotates the rotor 41 is attached to the stator core 42.

The α-phase first coil 23 (α1), the α-phase second coil 24 (α2), the β-phase first coil 33 (β1), and the β-phase second coil 34 (β2) are so-called open-ended coils, and ends of the coils α1, α2, β1, β2 are not connected to each other (that is, the coils α1, α2, β1, β2 are separated from each other) and are drawn out to the outside of the rotary electric machine 16.

The α-phase first coil 23 (α1) and the α-phase second coil 24 (α2) set, for example, a spatial phase difference from each other to be zero and are wound with respect to the different teeth of the stator core 42 in the same direction when seen from an axis line direction along a center axis of the rotary electric machine 16 (M). The α-phase first coil 23 (α1) and the α-phase second coil 24 (α2) are arranged, for example, so as to share part of a slot 43 formed in the stator core 42 and are magnetically coupled to each other in the same polarity.

The β-phase first coil 33 (β1) and the β-phase second coil 34 (β2) set, for example, a spatial phase difference from each other to be zero and are wound with respect to the different teeth of the stator core 42 in the same direction when seen from the axis line direction along the center axis of the rotary electric machine 16 (M). The β-phase first coil 33 (β1) and the β-phase second coil 34 (β2) are arranged, for example, so as to share part of the slot 43 formed in the stator core 42 and are magnetically coupled to each other in the same polarity.

The α-phase first coil 23 (α1), the α-phase second coil 24 (α2), the β-phase first coil 33 (β1), and the β-phase second coil 34 (β2) are arranged such that the α-phase first coil 23 (α1) and the α-phase second coil 24 (α2) do not magnetically interfere with the β-phase first coil 33 (β1) and the β-phase second coil 34 (β2) by setting the spatial phase difference from each other to be 90°.

For example, each coil α1, α2, β1, β2 is attached to the stator core 42 by concentrated winding, distributed winding, or the like, and the coils α1, α2, β1, β2 have the same number of winding as one another.

The rotary electric machine 16 (M) generates rotation power by performing a power running operation using electric power supplied from the first electric power conversion portion 12 and the second electric power conversion portion 13. For example, when the rotary electric machine 16 (M) is connected to a wheel of the vehicle, the rotary electric machine 16 (M) generates a travel drive force by the electric power supplied from the first electric power conversion portion 12 and the second electric power conversion portion 13. The rotary electric machine 16 (M) may generate electric power by performing a regeneration operation using rotation power input from the wheel side of the vehicle. For example, when the rotary electric machine 16 (M) is connected to the internal combustion engine of the vehicle, the rotary electric machine 16 (M) may generate electric power using the power of the internal combustion engine.

The gate drive unit 17 switches between ON (conduction) and OFF (cutoff) of each connection-disconnection device 25, 26, 35, 36, 39 and each switching element of the first electric power conversion portion 12 and the second electric power conversion portion 13 on the basis of a control signal received from the electronic control unit 18. For example, the gate drive unit 17 switches between ON (conduction) and OFF (cutoff) of each switching element of each full-bridge circuit 12a, 12b, 13a, 13b by outputting a gate signal generated by amplification, level shift, and the like of the control signal.

The electronic control unit 18 integrally controls an operation of each of the electric power control unit 10a and the rotary electric machine 16 (M). For example, the electronic control unit 18 is a software function unit that functions by a predetermined program being executed by a processor such as a CPU (Central Processing Unit). The software function unit is an ECU (Electronic Control Unit) that includes the processor such as a CPU, a ROM (Read Only Memory) that stores the program, a RAM (Random Access Memory) that temporarily stores data, and an electronic circuit such as a timer. At least a portion of the electronic control unit 18 may be an integrated circuit such as a LSI (Large Scale Integration).

The electronic control unit 18 generates a control signal indicating a timing when each connection-disconnection device 25, 26, 35, 36, 39 and each switching element of the first electric power conversion portion 12 and the second electric power conversion portion 13 are driven to ON (conduction) and OFF (cutoff). The electronic control unit 18 inputs the generated control signal to the gate drive unit 17.

The electric apparatus 10 includes, for example, a motor temperature sensor 40a (second temperature acquisition portion) and a battery temperature sensor 40b (first temperature acquisition portion). The motor temperature sensor 40a detects, for example, the temperature of the stator core 42 of the rotary electric machine 16 (M), the temperature of each coil α1, α2, β1, β2, the temperature of a refrigerant of a cooling circuit, or the like.

The battery temperature sensor 40b detects, for example, the temperature of each battery cell of the electric power storage device 11. The signal of a detection value (a motor temperature and a battery temperature) that is output from each of the motor temperature sensor 40a and the battery temperature sensor 40b is input to the electronic control unit 18.

### (Control Operation of Electric Apparatus)

The electronic control unit 18 sets the first connection-disconnection device 25 and the second connection-disconnection device 26 to be in an ON (conduction) state in the case of the power running operation or the regeneration operation of the rotary electric machine 16 (M). The electronic control unit 18 switches between a state in which the α-phase coils α1, α2 are connected in series and the β-phase coils β1, β2 are connected in series, and a state in which the α-phase coils α1, α2 are connected in parallel and the β-phase coils β1, β2 are connected in parallel by the switching between ON (conduction) and OFF (cutoff) of the first switch 22 and the second switch 32.

The electronic control unit 18 performs, for example, a feedback control or the like of a current in which a current detection value of the rotary electric machine 16 (M) and a current target value in response to a torque command value of the rotary electric machine 16 (M) are used and generates a control signal that commands the driving of each switching element of the first electric power conversion portion 12 and the second electric power conversion portion 13.

At the time of DC charging, that is, when the electric power storage device 11 is charged by the external DC electric power source connected to the DC electric power source connection portion 14, the electronic control unit 18 sets the first connection-disconnection device 25 and the second connection-disconnection device 26 to be in an ON (conduction) state. The electronic control unit 18 causes each of the combination of the α-phase coils α1, α2 and the first electric power conversion portion 12 and the combination of the β-phase coils β1, β2 and the second electric power conversion portion 13 to function as a non-insulation type DC-DC converter that performs a voltage increase operation by a so-called chopper control, for example, with respect to the external DC electric power source having a lower voltage than that of the electric power storage device 11.

At the time of AC charging, that is, when the electric power storage device 11 is charged by the external AC electric power source connected to the AC electric power source connection portion 15, the electronic control unit 18 sets the first connection-disconnection device 25 and the second connection-disconnection device 26 to be in an OFF (cutoff) state for insulation.

The electronic control unit 18 sets, for example, the α-phase first coil 23 (α1) and the α-phase second coil 24 (α2) that are magnetically coupled to each other in the same polarity to be a coil of a DC conversion phase (a phase) used for conversion between DC electric power. The electronic control unit 18 causes, for example, the combination of the α-phase coils α1, α2 and the first electric power conversion portion 12 to function as a DAB (Dual Active Bridge) type DC-DC converter which is an insulation-type bidirectional (voltage increase and voltage decrease) converter.

The electronic control unit 18 sets, for example, the β-phase first coil 33 (β1) and the β-phase second coil 34 (β2) that are magnetically coupled to each other in the same polarity to be a coil of an AC input phase (phase) connected to the external AC electric power source. The electronic control unit 18 causes, for example, the combination of the β-phase coils β1, β2 and the second electric power conversion portion 13 to function as a so-called full-bridgeless type (or bridgeless and totem pole type) power factor correction (PFC) circuit which converts AC electric power into DC electric power. The so-called bridgeless PFC is a PFC that does not include a bridge rectifier by a plurality of diodes which are connected by bridge connection. The so-called totem pole PFC is a PFC that includes a pair of switching elements of the same conductivity type which are connected (totem pole connection) in series in the same direction. The electronic control unit 18 performs the power factor correction of an input voltage Vac and an input current Iac while performing rectification of AC electric power received from the external AC electric power source into DC electric power and increasing the voltage, for example, by controlling the switching of each switching element in each full-bridge circuit 13a, 13b of the second electric power conversion portion 13.

The electronic control unit 18 heats the electric power storage device 11 and the rotary electric machine 16 (M) by causing a high-frequency current based on electric power that is output from the electric power storage device 11 to flow back to each of the first electric power conversion portion 12 and the second electric power conversion portion 13, for example, at the time of starting of the electric apparatus 10 or the like.

The electronic control unit 18 heats the electric power storage device 11 and the rotary electric machine 16 (M), for example, by controlling electric power supply of the coils α1, α2, β1, β2 in accordance with the signal of the detection value (the motor temperature and the battery temperature) that is output from each of the motor temperature sensor 40a and the battery temperature sensor 40b. For example, the electronic control unit 18 switches between and performs a first mode in which a heat generation amount of the electric power storage device 11 is larger than a heat generation amount of the rotary electric machine 16 (M) and a second mode in which a heat generation amount of the electric power storage device 11 is smaller than the heat generation amount of the electric power storage device 11 in the first mode.

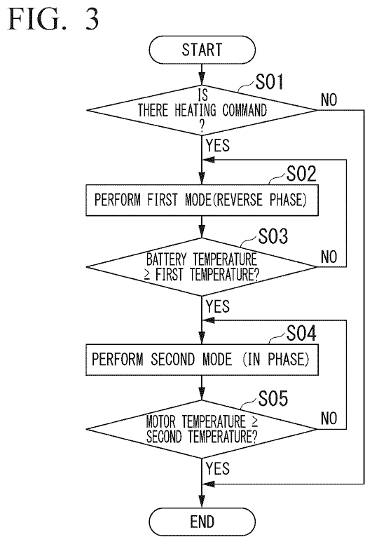

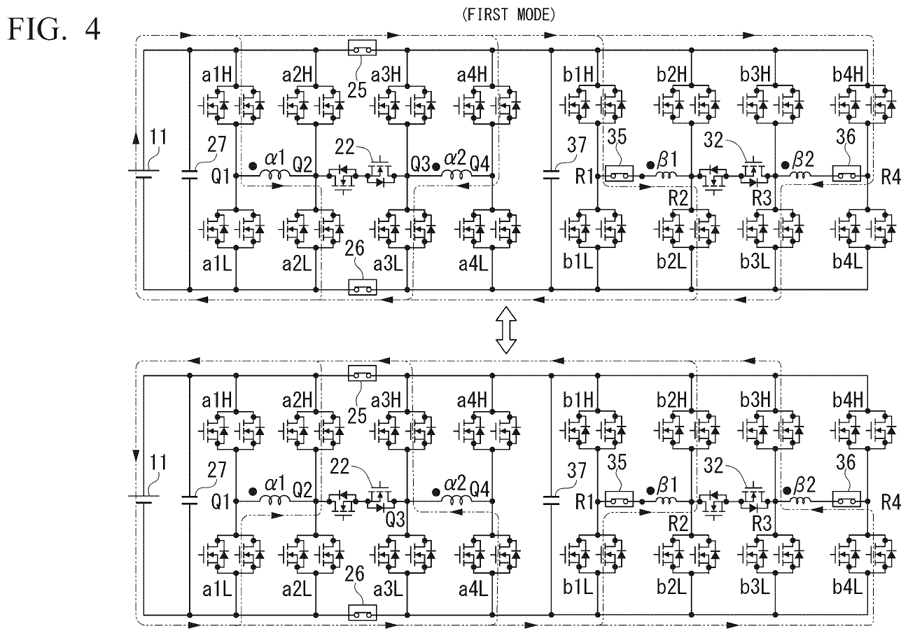

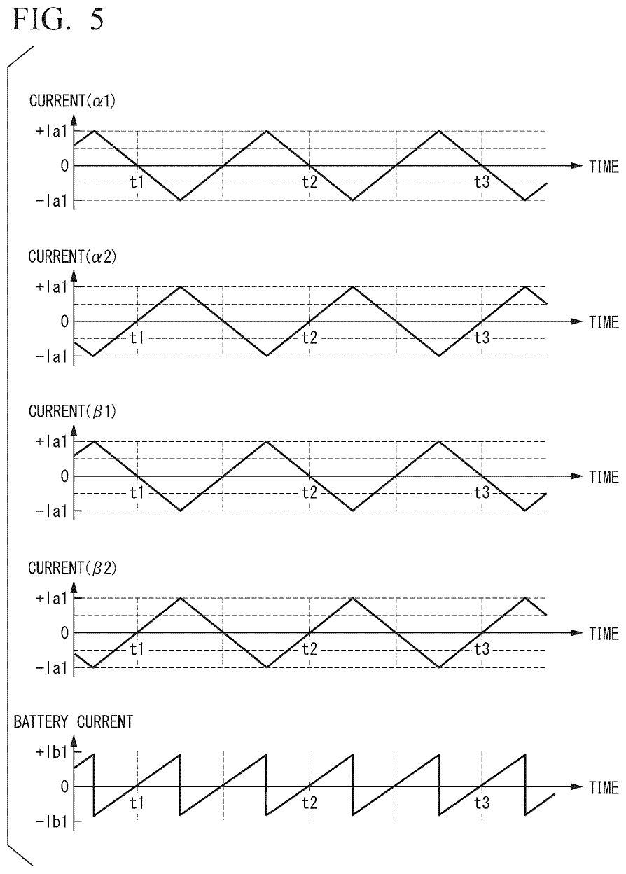

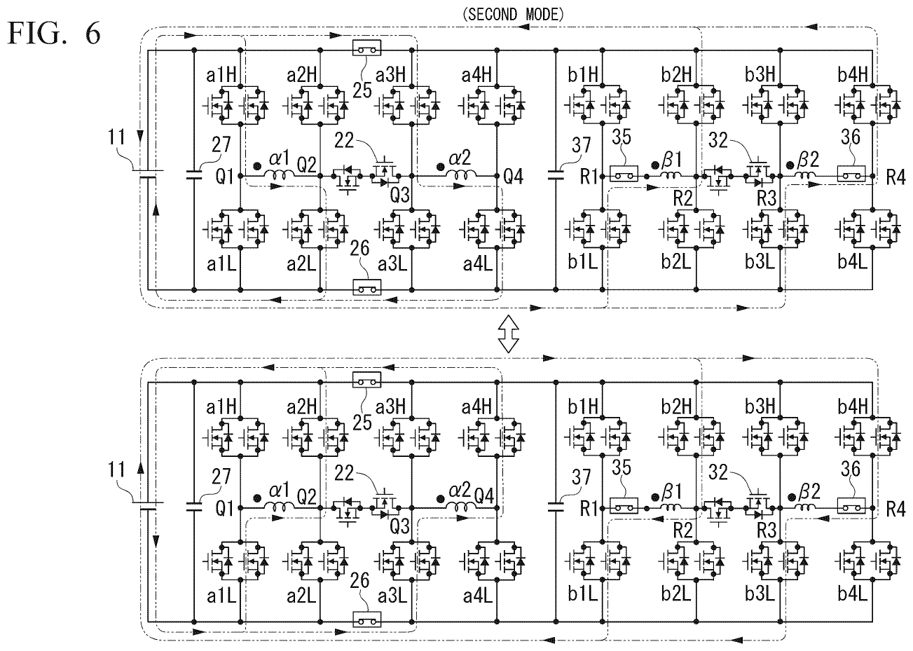

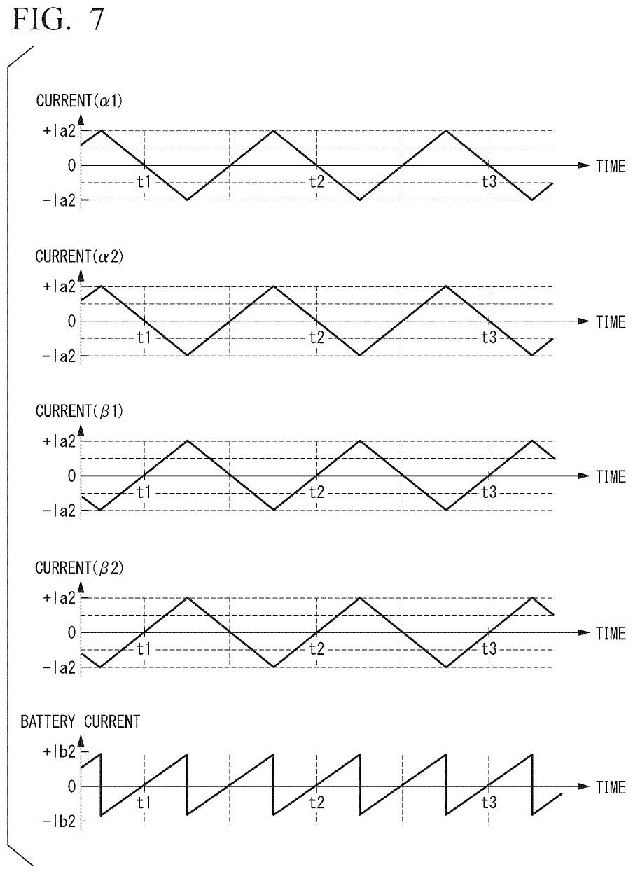

FIG. 3 is a flowchart showing an operation of the electric apparatus 10 of the embodiment. FIG. 4 is a circuit diagram showing the flow of a current in the first mode of the electric apparatus 10 of the embodiment. FIG. 5 is a view showing the change of a current that flows through each coil α1, α2, β1, β2 and the electric power storage device 11 in the first mode of the electric apparatus 10 of the embodiment. FIG. 6 is a circuit diagram showing the flow of a current in the second mode of the electric apparatus 10 of the embodiment. FIG. 7 is a view showing the change of a current that flows through each coil α1, α2, β1, β2 and the electric power storage device 11 in the second mode of the electric apparatus 10 of the embodiment.

First, in Step S01 shown in FIG. 3, the electronic control unit 18 determines whether or not there is a heating command that heats the electric power storage device 11 and the rotary electric machine 16 (M) by the electric power of the electric power storage device 11. When the determination result is “NO”, the electronic control unit 18 advances the process to the end. On the other hand, when the determination result is “YES”, the electronic control unit 18 advances the process to Step S02.

Next, in Step S02, the electronic control unit 18 performs the first mode in which the heat generation amount of the electric power storage device 11 is larger than the heat generation amount of the rotary electric machine 16 (M). For example, as shown in FIG. 4, in the first mode, the first switch 22 and the second switch 32 are set to be in an OFF (cutoff) state, and the first connection-disconnection device 25, the second connection-disconnection device 26, the third connection-disconnection device 35, and the fourth connection-disconnection device 36 are set to be in an ON (conduction) state. As shown in FIG. 4 and FIG. 5, in the first mode, the switching phases of the first full-bridge circuit 12a and the second full-bridge circuit 12b of the first electric power conversion portion 12 are in a reverse phase, and the switching phases of the third full-bridge circuit 13a and the fourth full-bridge circuit 13b of the second electric power conversion portion 13 are in a reverse phase. The phase difference between the switching phase in the first electric power conversion portion 12 and the switching phase in the second electric power conversion portion 13 is zero.

In the case of the first mode, currents in an opposite direction to each other flow to the α-phase first coil 23 (α1) and the α-phase second coil 24 (α2), respectively. The currents that flow through the α-phase coils 23 (α1), 24 (α2) are reverse-phase currents in which magnetic fluxes cancel each other out. The magnetic fluxes of the α-phase coils 23 (α1), 24 (α2) cancel each other out, and thereby, inductances of the α-phase coils 23 (α1), 24 (α2) are a leakage inductance by a leakage magnetic flux.

In the case of the first mode, currents in an opposite direction to each other flow to the β-phase first coil 33 (β1) and the β-phase second coil 34 (β2), respectively. The currents that flow through the β-phase coils 33 (β1), 34 (β2) are reverse-phase currents in which magnetic fluxes cancel each other out. The magnetic fluxes of the β-phase coils 33 (β1), 34 (β2) cancel each other out, and thereby, inductances of the β-phase coils 33 (β1), 34 (β2) are a leakage inductance by a leakage magnetic flux.

In the case of the first mode, by the inductance of each coil α1, α2, β1, β2 being small, the iron loss is small, and the rotary electric machine 16 (M) is heated substantially by the copper loss.

The frequency of the current that flows through the electric power storage device 11 in the first mode is twice the frequency of the current that flows through each coil α1, α2, β1, β2. In the case of the first mode, the ripple of the current that flows through the electric power storage device 11 is relatively larger than that of the second mode described later, and the heating of the electric power storage device 11 is promoted.

Next, in Step S03 shown in FIG. 3, the electronic control unit 18 determines whether or not the battery temperature acquired from the battery temperature sensor 40b is equal to or more than a predetermined first temperature. When the determination result is “NO”, the electronic control unit 18 repeatedly performs the process of Step S02. On the other hand, when the determination result is “YES”, the electronic control unit 18 advances the process to Step S04.

Next, in Step S04, the electronic control unit 18 performs the second mode in which the heat generation amount of the electric power storage device 11 is smaller than the heat generation amount of the electric power storage device 11 in the first mode. For example, as shown in FIG. 6, in the second mode, similarly to the first mode, the first switch 22 and the second switch 32 are set to be in an OFF (cutoff) state, and the first connection-disconnection device 25, the second connection-disconnection device 26, the third connection-disconnection device 35, and the fourth connection-disconnection device 36 are set to be in an ON (conduction) state. As shown in FIG. 6 and FIG. 7, in the second mode, the switching phases of the first full-bridge circuit 12a and the second full-bridge circuit 12b of the first electric power conversion portion 12 are in phase, and the switching phases of the third full-bridge circuit 13a and the fourth full-bridge circuit 13b of the second electric power conversion portion 13 are in phase. The phase difference between the switching phase in the first electric power conversion portion 12 and the switching phase in the second electric power conversion portion 13 is 180°.

In the case of the second mode, currents in the same direction as each other flow to the α-phase first coil 23 (α1) and the α-phase second coil 24 (α2), respectively. The currents that flow through the α-phase coils 23 (α1), 24 (α2) are in-phase currents in which magnetic fluxes do not cancel each other out. The magnetic fluxes of the α-phase coils 23 (α1), 24 (α2) do not cancel each other out, and thereby, inductances of the α-phase coils 23 (α1), 24 (α2) are a relatively larger inductance than that of the first mode.

In the case of the second mode, currents in the same direction as each other flow to the β-phase first coil 33 (β1) and the β-phase second coil 34 (β2), respectively. The currents that flow through the β-phase coils 33 (β1), 34 (β2) are in-phase currents in which magnetic fluxes do not cancel each other out. The magnetic fluxes of the β-phase coils 33 (β1), 34 (β2) do not cancel each other out, and thereby, inductances of the β-phase coils 33 (β1), 34 (β2) are a relatively larger inductance than that of the first mode.

In the case of the second mode, the inductance of each coil α1, α2, β1, β2 is relatively larger than that of the first mode, and the rotary electric machine 16 (M) is heated by the iron loss and the copper loss.

The frequency of the current that flows through the electric power storage device 11 in the second mode is twice the frequency of the current that flows through each coil α1, α2, β1, β2. The amplitude (Ib2) of the current that flows through the electric power storage device 11 in the second mode is relatively smaller than the amplitude (Ib1) of the current that flows through the electric power storage device 11 in the first mode. In the case of the second mode, the ripple of the current that flows through the electric power storage device 11 is relatively smaller than that of the first mode, and heat retention of the electric power storage device 11 is maintained.

Next, in Step S05 shown in FIG. 3, the electronic control unit 18 determines whether or not the motor temperature acquired from the motor temperature sensor 40a is equal to or more than a predetermined second temperature. When the determination result is “NO”, the electronic control unit 18 repeatedly performs the process of Step S04.

On the other hand, when the determination result is “YES”, the electronic control unit 18 advances the process to the end.

As described above, according to the electric apparatus 10 of the embodiment, by switching between and performing the first mode and the second mode in accordance with the temperature of each of the electric power storage device 11 and the rotary electric machine 16 (M), for example, even when the difference between the temperature of the electric power storage device 11 and the temperature of the rotary electric machine 16 (M) is large or the like, it is possible to appropriately control the temperature of each of the electric power storage device 11 and the rotary electric machine 16 (M).

By the switching between the reverse-phase state and the in-phase state of the switching phase, it is possible to reciprocally switch the magnitude of an iron loss corresponding to an inductance and the magnitude of a current or the magnitude of a current ripple corresponding to the inductance. For example, it is possible to easily adjust the relative amount of the heating of the electric power storage device 11 by the current ripple or the current and the heating of the rotary electric machine 16 (M) by the iron loss, and it is possible to realize power saving.

### Modification Example

Hereinafter, modification examples of the embodiment will be described. The same parts as those of the above-described embodiment are denoted by the same reference numerals, and descriptions thereof are omitted or simplified.

The above embodiment is described using an example in which in the case of the first mode, the phase difference between the switching phase in the first electric power conversion portion 12 and the switching phase in the second electric power conversion portion 13 is zero; however, the embodiment is not limited thereto. For example, the phase difference between the switching phase in the first electric power conversion portion 12 and the switching phase in the second electric power conversion portion 13 may be set to 90°.

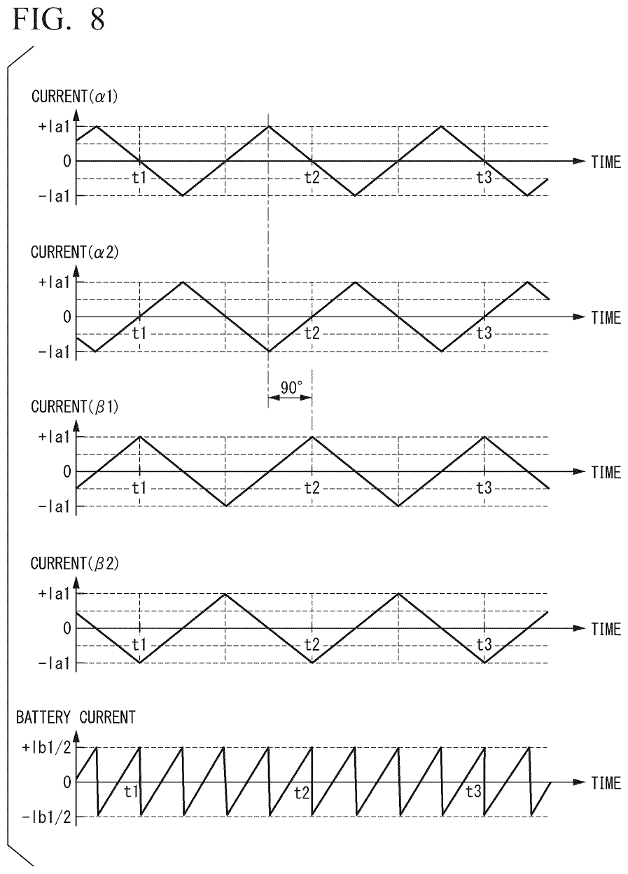

FIG. 8 is a view showing the change of a current that flows through each coil α1, α2, β1, β2 and an electric power storage device 11 in a first mode in an electric apparatus 10 of a first modification example of the embodiment.

As shown in FIG. 8, the frequency of a current that flows through the electric power storage device 11 in the first mode of the first modification example is twice the frequency of a current that flows through the electric power storage device 11 in the first mode of the embodiment described above. The amplitude (Ib1/2) of the current that flows through the electric power storage device 11 in the first mode of the first modification example is ½ of the amplitude (Ib1) of the current that flows through the electric power storage device 11 in the first mode of the embodiment described above.

According to the first modification example, it is possible to reduce the amplitude of the current that flows through the electric power storage device 11, and the relative amount of the heating of the electric power storage device 11 and the heating of the rotary electric machine 16 (M) can be adjusted in more detail.

The above embodiment is described using an example in which in the case of the second mode, the phase difference between the switching phase in the first electric power conversion portion 12 and the switching phase in the second electric power conversion portion 13 is 180°; however, the embodiment is not limited thereto. For example, the phase difference between the switching phase in the first electric power conversion portion 12 and the switching phase in the second electric power conversion portion 13 may be set to 90°.

The above embodiment is described using an example in which the electronic control unit 18 switches between the first mode and the second mode; however, the embodiment is not limited thereto. For example, the electronic control unit 18 may switch between and perform the first mode and a third mode (that is, replacement for the second mode) in which a heat generation amount of the electric power storage device 11 is smaller than the heat generation amount of the electric power storage device 11 in the first mode.

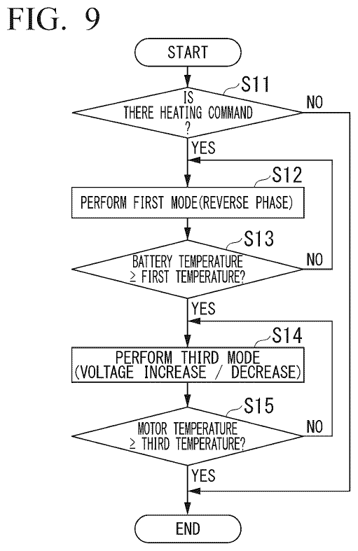

FIG. 9 is a flowchart showing an operation of an electric apparatus 10 in a second modification example of the embodiment.

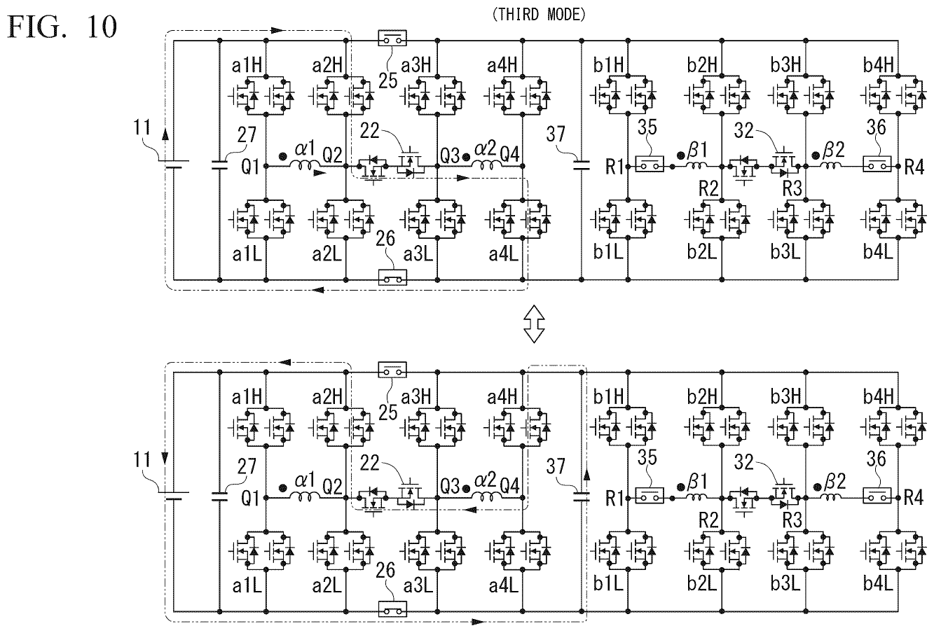

FIG. 10 is a circuit diagram showing the flow of a current of a third mode in the electric apparatus 10 of the second modification example of the embodiment. FIG. 11 is a view showing the change of a current that flows through an α-phase second coil 24 (α2) and an electric power storage device 11 in the third mode in the electric apparatus 10 of the second modification example of the embodiment.

First, in Step S11 shown in FIG. 9, the electronic control unit 18 determines whether or not there is a heating command that heats the electric power storage device 11 and the rotary electric machine 16 (M) by the electric power of the electric power storage device 11. When the determination result is “NO”, the electronic control unit 18 advances the process to the end. On the other hand, when the determination result is “YES”, the electronic control unit 18 advances the process to Step S12.

Next, in Step S12, the electronic control unit 18 performs the first mode in which the heat generation amount of the electric power storage device 11 is larger than the heat generation amount of the rotary electric machine 16 (M) similarly to Step S02 of the embodiment described above.

Next, in Step S13, the electronic control unit 18 determines whether or not the battery temperature acquired from the battery temperature sensor 40b is equal to or more than a predetermined first temperature. When the determination result is “NO”, the electronic control unit 18 repeatedly performs the process of Step S12. On the other hand, when the determination result is “YES”, the electronic control unit 18 advances the process to Step S14.

Next, in Step S14, the electronic control unit 18 performs the third mode in which the heat generation amount of the electric power storage device 11 is smaller than the heat generation amount of the electric power storage device 11 in the first mode. For example, as shown in FIG. 10, in the third mode, conversion between DC electric power is performed by the first electric power conversion portion 12. For example, in the third mode, the first connection-disconnection device 25 is set to be in an OFF (cutoff) state, and the first switch 22 and the second connection-disconnection device 26 are set to be in an ON (conduction) state. In the third mode, the ON state and the OFF state of the two element portions 21a (a4H), 21b (a4L) of the second full-bridge circuit 12b that form a fourth leg of the first electric power conversion portion 12 are alternately switched.

For example, in the third mode, in a state where the voltage of the capacitor (condenser) 37 is less than a withstand voltage of each element portion 21a (a4H), 21b (a4L), a duty corresponding to the ON (conduction) state of the high-side arm element portion 21a (a4H) is changed. For example, in accordance with the increase of the duty corresponding to the ON (conduction) state of the element portion 21a (a4H), the voltage of the capacitor (condenser) 37 and the current that flows through the α-phase second coil 24 (α2) increase.

As shown in FIG. 11, the frequency of the current that flows through the electric power storage device 11 in the third mode is the same as the frequency of the current that flows through the α-phase second coil 24 (α2). The amplitude (Ib3) of the current that flows through the electric power storage device 11 in the third mode is relatively smaller than the amplitude (Ib2) of the current that flows through the electric power storage device 11 in the second mode.

In the case of the third mode, the inductance of the α-phase second coil 24 (α2) is relatively larger than that of the first mode, and the rotary electric machine 16 (M) is heated by the iron loss and the copper loss.

In the case of the third mode, the ripple of the current that flows through the electric power storage device 11 is relatively smaller than that of the first mode, and heat retention of the electric power storage device 11 is maintained.

Next, in Step S15 shown in FIG. 9, the electronic control unit 18 determines whether or not the motor temperature acquired from the motor temperature sensor 40a is equal to or more than a predetermined third temperature. For example, the predetermined third temperature is lower than the predetermined second temperature in the embodiment described above. When the determination result is “NO”, the electronic control unit 18 repeatedly performs the process of Step S14. On the other hand, when the determination result is “YES”, the electronic control unit 18 advances the process to the end.

According to the second modification example, in the third mode, for example, as compared with the second mode of the embodiment described above or the like, it is possible to reduce the amplitude of a current that flows through the electric power storage device 11, and it is possible to prioritize the heating of the rotary electric machine 16 (M) with further power saving.

Table 1 described below shows a relative magnitude relationship between the battery current and the motor current in the embodiment, the first modification example, and the second modification example described above. Each of the battery current and the motor current changes in a decreasing tendency, for example, in accordance with sequential transition from the first mode to the second mode and from the second mode to the third mode.

TABLE 1

CURRENT

| MODE | BATTERY CURRENT | MOTOR CURRENT |
|---|---|---|
| FIRST MODE | LARGE (Ib1) | MIDDLE (Ia1) |
| (REVERSE PHASE) | | |
| FIRST MODE | MIDDLE (Ib1/2) | MIDDLE (Ia1) |
| (REVERSE PHASE: | | |
| 90° DISPLACEMENT) | | |
| SECOND MODE | SMALL (Ib2) | SMALL + IRON LOSS |
| (IN PHASE) | | (Ia2) |
| THIRD MODE | EXTREMELY SMALL | SMALL + IRON LOSS |
| (VOLTAGE INCREASE | (Ib3) | (Ia3) |
| OR DECREASE) | | |

The above embodiment is described using an example in which each of the α-phase first coil 23 (α1), the α-phase second coil 24 (α2), the β-phase first coil 33 (β1), and the β-phase second coil 34 (β2) is wound around the different teeth of the stator core 42; however, the embodiment is not limited thereto.

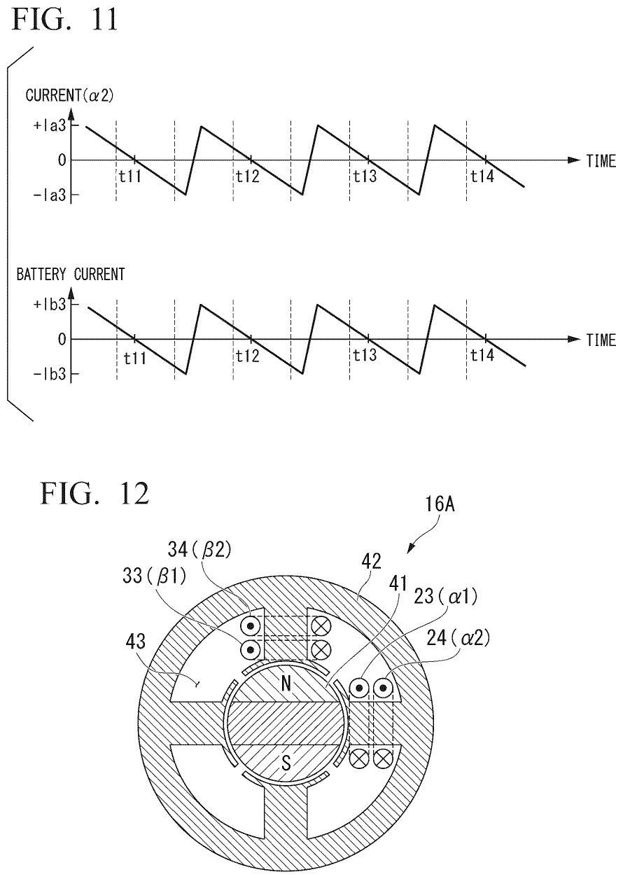

FIG. 12 is a configuration view of a rotary electric machine 16A of the electric apparatus 10 in a third modification example of the embodiment.

As shown in FIG. 12, the α-phase first coil 23 (α1) and the α-phase second coil 24 (α2) may be wound around the same teeth of the stator core 42, and the β-phase first coil 33 (β1) and the β-phase second coil 34 (β2) may be wound around the same teeth of the stator core 42.

The above embodiment is described using an example in which the second electric power conversion portion 13 includes the fifth connection-disconnection device 39; however, the embodiment is not limited thereto.

For example, the second electric power conversion portion 13 may include a sixth connection-disconnection device that is connected between the AC electric power source connection portion 15 and a connection point between the β-phase second coil 34 (β2) and the fourth connection-disconnection device 36 instead of the fifth connection-disconnection device 39.

The above embodiment is described using an example in which the β-phase first coil 33 (β1) and the β-phase second coil 34 (β2) are magnetically coupled to each other in the same polarity; however, the embodiment is not limited thereto. The β-phase first coil 33 (β1) and the β-phase second coil 34 (β2) may be magnetically coupled to each other in an opposite polarity. In this case, for example, a connection-disconnection device that is connected between one end of the β-phase first coil 33 (β1) and the neutral point R2 of the second phase of the third full-bridge circuit 13a or a connection-disconnection device that is connected between one end of the β-phase second coil 34 (β2) and the neutral point R3 of the first phase of the fourth full-bridge circuit 13b may be provided.

The above embodiment is described using an example in which, as a parallel pattern, the DC electric power source connection portion 14 is connected to the negative electrode of the second electric power conversion portion 13 and to the neutral point (that is, between the two transistors connected reversely in series) of each of the first switch 22 and the second switch 32; however, the embodiment is not limited thereto. For example, as a series pattern, the DC electric power source connection portion 14 may be connected to the negative electrode of the second electric power conversion portion 13 and to the neutral point Q4 of the first electric power conversion portion 12 and the neutral point R4 of the second electric power conversion portion 13. For example, as another parallel pattern, the DC electric power source connection portion 14 may be connected to the negative electrode of the second electric power conversion portion 13 and to the neutral points Q2, Q4 of the first electric power conversion portion 12 and the neutral points R2, R4 of the second electric power conversion portion 13.

The embodiments of the present invention have been presented as examples and are not intended to limit the scope of the invention. The embodiments can be implemented in a variety of other modes, and various omissions, substitutions, and modifications can be made without departing from the scope of the invention. The embodiments and modifications thereof are included within the scope and the gist of the invention and are also included within the scope of the invention described in the appended claims and equivalents thereof.

What is claimed is:

1. An electric apparatus comprising:
an electric power storage device;
a rotary electric machine having a plurality of coils;
an electric power control unit that is connected to the electric power storage device and the rotary electric machine and controls electric power transfer of each of the electric power storage device and the rotary electric machine;
a first temperature acquisition portion that acquires a temperature of the electric power storage device; and
a second temperature acquisition portion that acquires a temperature of the rotary electric machine,
wherein by controlling electric power supply of the plurality of coils in accordance with each temperature acquired by the first temperature acquisition portion and the second temperature acquisition portion, the electric power control unit switches between and performs a first mode in which a heat generation amount of the electric power storage device is larger than a heat generation amount of the rotary electric machine and a second mode in which a heat generation amount of the electric power storage device is smaller than the heat generation amount of the electric power storage device in the first mode.

2. The electric apparatus according to claim 1,
wherein the rotary electric machine comprises a stator core on which a slot is formed,
the plurality of coils comprises:
a plurality of first coils that share the slot of the stator core and are magnetically coupled; and
a plurality of second coils that share the slot of the stator core and are magnetically coupled,
the electric power control unit comprises:
a plurality of first full-bridge circuits connected to the plurality of first coils; and
a plurality of second full-bridge circuits connected to the plurality of second coils,
a switching phase of each of the plurality of first full-bridge circuits and the plurality of second full-bridge circuits is in a reverse phase in the first mode, and
the switching phase of each of the plurality of first full-bridge circuits and the plurality of second full-bridge circuits is in phase in the second mode.

3. The electric apparatus according to claim 2,
wherein spatial phases of the plurality of first coils and the plurality of second coils are orthogonal to each other,
the plurality of first coils and the plurality of second coils are open-ended,
the electric power control unit sets a phase difference between the switching phase of the plurality of first full-bridge circuits and the switching phase of the plurality of second full-bridge circuits to be 90° in accordance with each temperature acquired by the first temperature acquisition portion and the second temperature acquisition portion.

4. The electric apparatus according to claim 1,
wherein the rotary electric machine comprises a stator core on which a slot is formed,
the plurality of coils comprises:
a plurality of first coils that share the slot of the stator core and are magnetically coupled; and
a plurality of second coils that share the slot of the stator core and are magnetically coupled,
the electric power control unit comprises:
a plurality of first full-bridge circuits that are connected to the plurality of first coils;
an inter-coil connection-disconnection device that is connected between the plurality of first coils;
two connection-disconnection devices that are connected between positive electrodes and between negative electrodes of the plurality of first full-bridge circuits; and
a plurality of second full-bridge circuits that are connected to the plurality of second coils,
a switching phase of each of the plurality of first full-bridge circuits and the plurality of second full-bridge circuits is in a reverse phase in the first mode, and
in the second mode, conversion between DC electric power is performed by the plurality of first full-bridge circuits by causing the inter-coil connection-disconnection device to be in a connection state, causing a first connection-disconnection device of the two connection-disconnection devices to be in a disconnection state, and causing a second connection-disconnection device of the two connection-disconnection devices to be in a connection state.
